(19) United States
(12) Patent Application Publication
(10) Pub. No.: US 2001/0028169 A1
(43) Pub. Date: Oct. 11, 2001

(54) Method for providing a security element for documents, forgery-proof labels, checks, seals and the like

(75) Inventor: Maurizio Lazzerini, Cerro Al Lambro (IT)

Correspondence Address: MODIANO & ASSOCIATI, Via Meravigli, 16, Milano, 20123, IT

(73) Assignee: ELMIVA S.a.s. di WALTER MANTEGAZZA & C.

(21) Appl. No.: 09/828,175

(22) Filed: Apr. 9, 2001

(30) Foreign Application Priority Data
Apr. 10, 2000 (IT) MI2000A000773

(51) Int. Cl. B42D 15/00; B42D 15/10; G09C 3/00

(52) U.S. Cl. 283/84; 283/74

(57) ABSTRACT

A method for manufacturing a security element for documents, forgery-proof labels, checks, seals and the like, comprising the steps of providing a backing layer and applying a covering layer to at least one face of the backing layer. The method also comprises a step of removing preset regions of the covering layer with a laser beam having a wavelength between 900 and 1200 nm. The preset regions define a code which can be customized in any manner and detected in any manner.

### BACKGROUND OF THE INVENTION

The present invention relates to a method for providing a security element for documents, forgery-proof labels, checks, seals and the like, and to the security element thus provided.

It is known that one of the security elements most commonly used through the years in documents and the like is a thread which is inserted in the paper mix during production.

Such thread has evolved considerably through the years, passing from a simple polyester thread on which a solid-backing covering layer of magnetic material or a continuous layer of aluminum was spread, to the threads currently used, which have a much higher degree of sophistication.

Recently, threads have been marketed which simultaneously have a plurality of characteristics and are inserted in a single document.

Moreover, security threads are currently used which allow to have both visual solutions and code-containing solutions; the two types are obviously manufactured with various systems which can be, for example, as regards the visual characteristics, the partial demetallization of the aluminum, without altering the concept of metallic and electrical continuity, or more simply the negative printing of the text by using aluminum-colored inks, adding them to the coding characteristics, which are currently mainly magnetic.

Regardless of the type of security element provided on the threads, the threads are manufactured repetitively and they all have the same visual and magnetic characteristics; accordingly, it is not possible to introduce a customizable element which varies according to parameters which can be used within the same production.

Considering for example the Italian 50,000-lire bills, two security threads are used for such bills: one has visual characteristics which are printed in negative with aluminum-colored inks, and the other thread has a dark appearance and bears a security code; in these threads, both the negative text and the security code remain exactly identical for all printed and issued bills.

It should also be noted that the public gives considerable importance to these two elements, since they are always analyzed during negotiation; moreover, the second thread, which bears a code that is detectable by devices, has become particularly important, since it is used to handle the bill by means of devices which operate without human intervention, entrusting approval of the validity of the bill to the interpretation of the code.

One can easily imagine what might happen if the thread were removed from a genuine bill and inserted between two white pieces of paper or if the code of a bill were examined carefully and then reproduced always identically, since there is no possibility of identification.

### SUMMARY OF THE INVENTION

The aim of the present invention is to eliminate the above drawbacks, by providing a security element which has one or more of the current visual and coded characteristics, such characteristics being however implemented by a part which is variable both as regards the visual characteristics and as regards the coding characteristics.

Within this aim, an object of the invention is to provide a security element which can be customized in steps performed after production of the thread, for example, and therefore not only by the thread manufacturer but also when the threads are used, for example in the paper mill prior to the insertion of the threads in paper or cardboard; during weaving, if the thread is used for woven security labels, identifying for example the production site and any other useful data; during final use, if the system is applied to a thread which is actually a tape for closing packages, inserting characteristics which relate to all the manufacturing parameters that are useful for identifying the process as well as the product.

Moreover, the customizable characteristics can be applied during labeling if the thread is applied to packages, as if the thread itself were a seal with optical characteristics for the public and coded characteristics for decoding devices.

A particular object of the invention is to use a security thread which, if used with a windowing technique, i.e., when the thread weaves in and out of the paper, allows to customize the thread, which is composed of two coupled layers of polyester between which there is an optical or magnetic layer or a layer having other characteristics.

This aim and these and other objects which will become better apparent hereinafter are achieved by a method for manufacturing a security element for documents, forgery-proof labels, checks, seals and the like, comprising the steps of: providing at least one backing layer and applying a covering layer to at least one face of said at least one backing layer, characterized in that it also comprises the step of removing preset regions of said covering layer with a laser beam having a wavelength between 900 and 1200 nm, said preset regions defining a code which can be customized in any manner and detected in any manner.

### BRIEF DESCRIPTION OF THE DRAWINGS

Further characteristics and advantages of the present invention will become better apparent from the following detailed description of a preferred but not exclusive embodiment thereof, illustrated only by way of non-limitative example with the aid of the accompanying drawings, wherein:

FIG. 1 is a schematic view of the step of preparing a band provided with visible elements, magnetic elements, and customizable elements;

FIG. 2 is a schematic sectional view of a thread obtained by means of coupled tapes;

FIG. 3 is a view of the provision of a region obtained with a laser using a closely-spaced technique;

FIG. 4 is a view of a region obtained with a laser using a matrix technique.

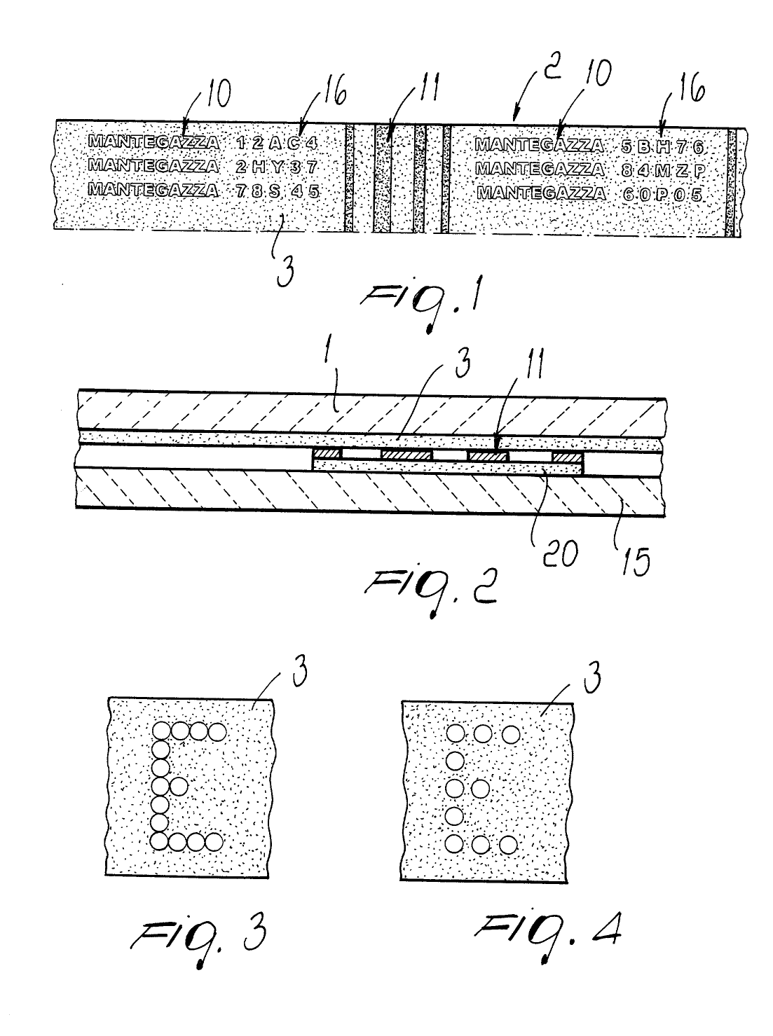

### DESCRIPTION OF THE PREFERRED EMBODIMENTS

With reference to the figures, the method for manufacturing a security element for documents, forgery-proof labels, checks, seals and the like substantially consists in providing a backing layer, designated by the reference numeral 1, which is advantageously made of polyester and is provided by cutting from a band 2 on which there is a covering layer, designated by the reference numeral 3, which is constituted for example by ink, a metallic layer or a magnetic layer.

In the simplest embodiment, it is possible to provide on the covering layer 3 preset regions which are removed by means of a laser beam which has a wavelength between 900 and 1200 nm.

In this manner it is possible to customize a security thread whereon the user can apply lettering, codes or elements deemed appropriate, with the possibility to vary the codes or lettering according to the contingent requirements.

Considering for example the specific case of a thread which has a plurality of identification elements, it is possible to provide on the thread a first region 10, in which optically detectable elements are provided which are obtained either by vacuum metallization from 30 to 350 thousandths of a micron, subsequently treated with various systems in order to provide the effect of partial demetallization of letters, screen-printing numerals and the like, or optionally by providing the covering layer 3 by printing ink, generally an aluminum-colored ink implemented by means of pigments or dyes with other optional characteristics such as fluorescence, reflectivity, UV- and/or IR-absorption, on which the letters are printed in negative.

The covering layer can optionally be provided by transferring material.

Adjacent to the region 10, it is possible to provide a coding region 11 which is generally obtained by means of magnetic materials with various characteristics in terms of coercivity, residual magnetism, and squaring; these materials are deposited in various forms or with different thicknesses, obtaining a very wide range of per se known coding; the magnetic codes are usually covered by a masking layer 20.

The assembly is completed by a second backing layer 15 which internally encloses the covering layer, which can be provided in various types.

The particular characteristic is constituted by the fact that a space 16 designed to customize the security element, is provided on the thread.

Such customization is provided by means of a laser beam which has a solid-state source of the Nd:Yag type, of the lamp or diode-source type with power levels ranging from 2 to 150 watts.

The diode laser is particularly recommended, since it does not require cooling and particular maintenance and is also easy to use.

The laser beam is used, by means of suitable optical devices, by arranging the intervention points as mutually close as possible, so that the customizations provided by removing preset regions of the covering layer 3 appear to be formed by means of a continuous line, or by spacing the points by using matrix-type techniques, as shown schematically in FIGS. 3 and 4.

In the case of a closely-spaced technique, the quality is obviously higher but the speed is lower, while in the second case the speed is higher and the quality is lower.

Assuming that a layer of vacuum-deposited aluminum with a thickness of 170-190 thousandths of a micron is removed, one of the types of laser to be used is the one with a solid-state source and a diode-based pumping system which operates with a wavelength of 1064 nm, with a working beam thickness of 10 to 90 microns; a beam of this type allows to write text at a rate of 1 meter per second with 10 W of power.

A laser of this type, driven by a computer with associated software, can be fitted on the cutting line of the supply reel or during the rewinding of the security thread.

Customization can be provided for the magnetic codes as well: in this case it is necessary to reserve a solid-backing part of magnetic material on which one intervenes with the laser beam in order to remove the magnetic material in shapes that can be recognized by dedicated devices.

One of the preferred but non-limitative embodiments is to remove areas of magnetic material having a regular shape, for example bars, so as to provide regions in which magnetic material is present alternated with regions having no magnetic material.

The variation of the lengths of the magnetic regions and/or of the regions having no magnetic material allows to generate waveforms which create different codes when they are interpreted.

Clearly, both the visual characteristic and the coded characteristic can be provided by removing different materials, and this system can, in some cases, replace the fixed lettering provided with the method used up to now.

An important characteristic of the invention consists of the fact that the use of a laser with a wavelength between 900 and 1200 nm, preferably between 1030 and 1100 nm, can remove the covering layer by passing through the polyester backing without affecting it at all, thus preserving all the physical and chemical characteristics that are useful and necessary for their industrial use.

It is thus evident that it is possible to provide a thread which is obtained, for example, even by means of two coupled layers and subsequently customize the thread, since removal of the layer can be obtained inside the two covering layers, and it is also optionally possible to customize the thread after it has been inserted in the paper, providing, by means of the removed regions, a code which can be correlated to specific elements of, for example, a given bill, such as the serial number.

It is possible to provide visual characteristics, i.e., the conventional lettering, on the thread with an output power of 8 watts with a feed rate of 120 centimeters per second and with the beam focused automatically in order to remove parts of aluminum or ink with extreme precision (30 microns±5 microns), writing letters and/or digits, since with the laser beam having a wavelength of 1064 nm it is possible to act directly on the material to be removed or through the polyester, since the latter is fully transparent to the laser beam.

In order to obtain coding characteristics, the materials used are generally magnetic materials with various characteristics of coercivity, residual magnetism, and squaring; these materials are deposited in various manners which can entail identical surfaces but different thicknesses or identical thicknesses but lengths which are a multiple of a single modulus, in order to provide a magnetic coded thread; with this system is convenient to have a fully magnetic region on which to act.

In practice, an area is provided in which the magnetic ink is deposited; such area can be interleaved with a fixed code provided for example with a conventional technique.

It is also possible to provide a fully magnetic area dedicated to the variable code with a thickness of 10 microns; in order to remove it, it is sufficient to increase the power of the laser, raising it to 10 watts, and reduce the writing speed to 100 centimeters per second, shifting the focus by approximately 1.5 millimeters, so as to remove part of the magnetic region, thus forming bars which are fully similar to the ones deposited with the known method, with the possibility to vary them in any manner and according to any type of code and correlation to be obtained.

From the above description it is thus evident that the invention achieves the intended aim and objects, and in particular the fact is stressed that a method and a corresponding security element are provided which can combine conventional characteristics with the presence of a code which can be customized in any way and can be correlated in any way to characteristics of the element on which the security element is applied.

The invention thus conceived is susceptible of numerous modifications and variations, all of which are within the scope of the inventive concept.

All the details may further be replaced with other technically equivalent elements.

In practice, the materials employed, as well as the contingent shapes and dimensions, may be any according to requirements.

The disclosures in Italian Patent Application No. MI2000A000773 from which this application claims priority are incorporated herein by reference.

What is claimed is:

1. A method for manufacturing a security element for documents, forgery-proof labels, checks, seals and the like, comprising the steps of providing a backing layer and applying a covering layer to at least one face of said backing layer, the method further comprising the steps of removing preset regions of said covering layer with a laser beam having a wavelength between 900 and 1200 nm, said preset regions defining a code which can be customized in any manner and detected in any manner.

2. The method according to claim 1, wherein said covering layer is constituted by ink.

3. The method according to claim 1, wherein said covering layer is constituted by a metallic layer.

4. The method according to claim 1, wherein said covering layer is constituted by an aluminum layer.

5. The method according to claim 1, wherein said covering layer is constituted by a magnetic layer.

6. The method according to claim 1, comprising a second backing layer which is applied to the other face of said covering layer, said laser beam acting on said covering layer through one of said backing layers.

7. The method according to claim 1, wherein said backing layer is constituted by a band or tape which can be separated in order to obtain threads, said band forming in succession a first region for obtaining optically detectable characters provided by means of conventional methods, said first regions being interleaved with regions for forming, in the covering layer, preset regions for obtaining said code which can be customized in any manner and detected in any manner.

8. The method according to claim 7, comprising, on said band, a region which can be coded and can be interleaved with said first region with optically detectable characters and with said region provided with a code which can be customized in any manner and detected in any manner.

9. The method according to claim 1, wherein said laser beam has a solid-state source of the Nd:Yag type.

10. The method according to claim 1, wherein said laser beam has a frequency which is preferably comprised between 1030 and 1100 nm.

11. The method according to claim 1, wherein said laser beam has a wavelength of 1064 nm.

12. The method according to claim 1, wherein said step of removing said preset regions is performed while said backing layer is inserted in a sheet of paper.

13. A security element for documents, forgery-proof labels, checks, seals and the like, comprising at least one backing layer on one face of which there is at least one covering layer, the security element further comprising, on said covering layer, preset regions with removal of said covering layer by means of a laser beam having a wavelength between 900 and 1200 nm, said preset regions forming a code which can be customized in any manner and detected in any manner.

14. The security element according to claim 13, comprising a first region with optically detectable characters and a region with said code which can be customized in any manner and detected in any manner, said regions being mutually interleaved.

15. The security element according to claim 13, further comprising interleaved regions which have optically detectable characters, magnetic codes and said code which can be customized in any manner and detected in any manner.

16. The security element according to claim 13, further comprising a second backing layer which encloses said covering layer and wherein said preset regions can be provided on said covering layer by means of said laser beam which passes through one of said backing layers.
